(19) United States
(12) Patent Application Publication
(10) Pub. No.: US 2026/0003052 A1
(43) Pub. Date: Jan. 1, 2026

(54) HARDWARE-BASED PRESENCE SENSOR SYSTEM AND METHOD OF OPERATION

(71) Applicants: Alexis Maximiliano Fueyo Vertnik, La Plata (AR); Alan Nicolas Melo y Cepero, Caba (AR); Juan Ignacio Talpone, Barcelona (ES); Christopher Enrique Lemme, Miami Lakes, FL (US)

(72) Inventors: Alexis Maximiliano Fueyo Vertnik, La Plata (AR); Alan Nicolas Melo y Cepero, Caba (AR); Juan Ignacio Talpone, Barcelona (ES); Christopher Enrique Lemme, Miami Lakes, FL (US)

(21) Appl. No.: 18/760,253

(22) Filed: Jul. 1, 2024

(51) Int. Cl. G01S 13/04; G01D 11/24; G01D 21/02; G01S 13/86; G01V 8/10

(52) U.S. Cl. CPC G01S 13/04; G01D 11/245; G01D 21/02; G01S 13/867; G01V 8/10

(57) ABSTRACT

A hardware-based presence sensor system and method of operation that includes providing a hardware computer chip with a microcontroller, an environmental sensor configured to measure intensity of ambient light, ambient temperature, ambient humidity, atmospheric pressure, and ambient carbon dioxide, a thermal camera configured to detect, track, and count a person, animal, or predetermined physical object, with a radar sensor configured to detect, track, and count a person, animal, or predetermined physical object in an ambient environment with an emitted radio frequency, and with a passive infrared sensor configured to detect changes in ambient infrared radiation. The microcontroller is operably configured to independently receive presence signals from each of the environmental sensor, thermal camera, the radar sensor, and the passive infrared sensor and execute a programmed presence algorithm utilizing the presence signals to generate a presence detection electronic-based indicator.

### FIELD OF THE INVENTION

The present invention relates generally to presence sensors and, more particularly, relates to a hardware-based presence sensor system and method of operation configured to utilize multiple sensing devices for effective detection of objects, people, and animals.

### BACKGROUND OF THE INVENTION

Detecting objects, people, and animals in an effective and efficient is highly desirable. To that end, detection sensors are widely utilized by users and devices, particularly IoT devices, to detect the presence of objects, people, and/or animals. Creating a single system or hardware component to accurately and efficiently detect a desired target has been lacking in the known art. For example, some known detection sensor systems collect presence data from multiple remote sensors and, utilizing one or more threshold programming standards, generate a presence indicator. These systems are generally high cost and impractical in their commercial application.

These known devices and systems that utilize multiple sensors also do not specially configure these sensors in a manner that generates a low area footprint or in a manner that reduces the possibility of false positive presence indicators. Those known systems that do have protocols and configurations to reduce the likelihood of false positive presence indicators utilize complicated and unreliable factors such as reference velocity to the sensor housing.

Therefore, a need exists to overcome the problems with the prior art as discussed above.

### SUMMARY OF THE INVENTION

The invention provides a hardware-based presence sensor system and method of operation that overcomes the hereinafore-mentioned disadvantages of the heretofore-known devices and methods of this general type as it integrates multiple specially configured sensors and software embedded or accessible to a microcontroller to augment the strength of each sensor and mitigate their potential weaknesses in ascertaining presence of an object, person, or animal. For example, millimeters sensors utilized in presence sensor system are very sensitive and can detect breathing through clothes but will also detect the motion of a house plant leaf or the neighbors moving in the apartment next door through the drywall. As such, having a reliable, cost-effective, and efficient presence assembly, system, and method of operation are important.

The hardware-based presence sensor system and method of operation can be used for security, fall detection, elderly monitoring, home automation, and many more applications. To that end, while the sensor may detect “presence”, it may also include the ability to count and positionally trace objects, people, and animals. Embodiments of the present invention may also be operable to monitor location, speed, direction, and horizontal or vertical position angle of an object, person, or animal. The system is also capable of measuring environmental variables such as temperature, humidity, atmospheric pressure, light intensity, and carbon dioxide.

With the foregoing and other objects in view, there is provided, in accordance with the invention, a hardware-based presence sensor system and method of operation that includes a hardware computer chip with a microcontroller, with at least one environmental sensor operably and communicatively coupled with the microcontroller and configured to measure intensity of ambient light, ambient temperature, ambient humidity, atmospheric pressure, and ambient carbon dioxide, with at least one thermal camera operably and communicatively coupled with the microcontroller and configured to detect, track, and count a person, animal, or predetermined physical object, with at least one radar sensor operably and communicatively coupled with the microcontroller and configured to detect, track, and count a person, animal, or predetermined physical object in an ambient environment with an emitted radio frequency, and with at least one passive infrared sensor operably and communicatively coupled with the microcontroller and configured to detect changes in ambient infrared radiation, wherein the microcontroller is operably configured to independently receive presence signals from each of the at least one environmental sensor, the at least one thermal camera, the at least one radar sensor, and the passive infrared sensor and is operable to execute a programmed presence algorithm utilizing the presence signals to generate a presence detection electronic-based indicator.

In accordance with another feature, an embodiment of the present invention includes the hardware computer chip having a network interface operably configured to selectively and communicatively couple an ancillary electronic computing device to the microcontroller.

In accordance with yet another feature, an embodiment of the present invention also includes a second microcontroller operably configured to selectively and wirelessly communicatively couple with an ancillary electronic computing device and provide presence signals thereto.

In accordance with a further feature of the present invention, the programmed presence algorithm associates a mathematical weight favoring at least one of the presence signals and each of the presence signals is associated with a positive indication of presence of the person, animal, or predetermined physical object.

In accordance with an additional feature of the present invention, the at least one radar sensor is configured to ascertain the relative speed of the person, animal, or predetermined physical object in the ambient environment with the emitted radio frequency.

In accordance with an exemplary feature, an embodiment of the present invention also includes a housing body housing the hardware computer chip, the least one environmental sensor, the at least one thermal camera, the at least one radar sensor, and the passive infrared sensor, wherein the housing body defines an ethernet port with an ethernet connector disposed therein and electrically and communicatively coupled to the hardware computer chip.

In accordance with an additional feature, an embodiment of the present invention also includes a housing body housing the hardware computer chip, the least one environmental sensor, the at least one thermal camera, the at least one radar sensor, and the passive infrared sensor, wherein the housing body defines a USB port with a USB connector disposed therein and electrically coupled to the hardware computer chip.

In accordance with an additional feature of the present invention, the at least one environmental sensor and the at least one thermal camera are communicatively coupled with the microcontroller with a serial protocol configuration.

In accordance with a further feature, an embodiment of the present invention also includes the at least one environmental sensor having or consisting essential of a light sensor operably and communicatively coupled with the microcontroller and configured to measure the intensity of the ambient light, a pressure, temperature, and humidity sensor operably and communicatively coupled with the microcontroller and configured to measure the ambient temperature, ambient humidity, and atmospheric pressure, and a carbon dioxide “CO₂” sensor operably and communicatively coupled with the microcontroller and configured to measure the ambient carbon dioxide.

In accordance with yet another feature, an embodiment of the present invention also includes a housing body housing the hardware computer chip, the least one environmental sensor, the at least one thermal camera, the at least one radar sensor, and the passive infrared sensor, wherein the housing body defines an LED indicator port with at least one LED disposed therein communicatively coupled to the microcontroller, the at least one environmental sensor, and the at least one passive infrared sensor.

In accordance with an additional feature of the present invention, the microcontroller is operably configured to receive a universally unique identifier from a portable beacon associated using a short-range wireless low energy protocol, the universally unique identifier including a physical location of the portable beacon.

Also in accordance with the present invention, a hardware-based presence sensor system is disclosed that includes a hardware computer chip with a microcontroller operably and communicatively coupled with at least one environmental sensor configured to measure intensity of ambient light, ambient temperature, ambient humidity, atmospheric pressure, and ambient carbon dioxide, with at least one thermal camera configured to detect, track, and count a person, animal, or predetermined physical object, with at least one radar sensor configured to detect, track, and count a person, animal, or predetermined physical object in an ambient environment with an emitted radio frequency, and with at least one passive infrared sensor configured to detect changes in ambient infrared radiation, wherein the microcontroller is operably configured to independently receive presence signals from each of the least one environmental sensor, the at least one thermal camera, the at least one radar sensor, and the passive infrared sensor and to execute a programmed presence algorithm utilizing the presence signals to generate a presence detection electronic-based indicator.

Although the invention is illustrated and described herein as embodied in a hardware-based presence sensor system and method of operation, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not necessarily drawn to scale but, where applicable, may be utilized to support a particular structural configuration or geometric relationship between components utilized in the assembly.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. As used herein, the term “wall” is intended broadly to encompass continuous structures, as well as, separate structures that are coupled together so as to form a substantially continuous external surface. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the computer chip or other referencing structure.

In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram depicting a hardware-based presence sensor system in accordance with one embodiment of the present invention; and

FIG. 2 depicts a process flow diagram illustrating an exemplary programmed presence algorithm process or method operation associated with the hardware-based presence sensor system in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

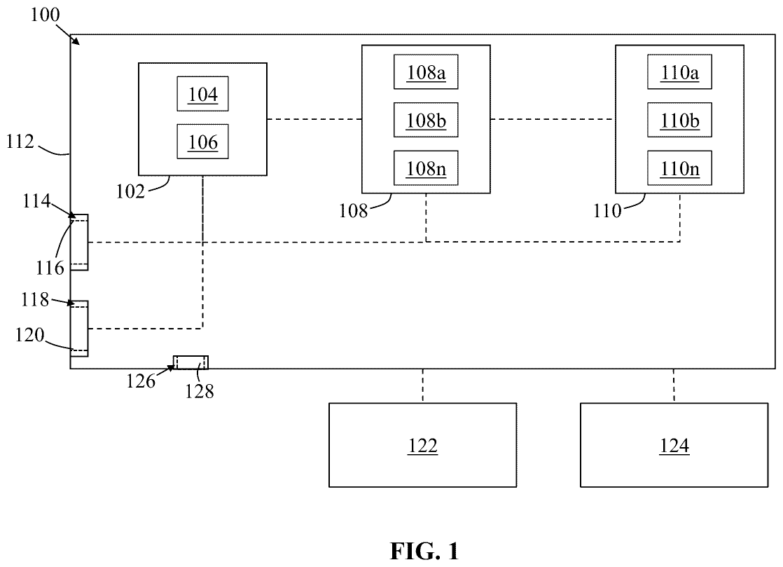

Referring now to FIG. 1, one embodiment of the present invention is shown in a block diagram views. FIG. 1 shows several advantageous features of the present invention, but, as will be described below, the invention can be provided in several shapes, sizes, combinations of features and components, and varying numbers and functions of the components. Specifically, the present invention provides a novel and efficient hardware-based presence sensor system or device that includes a hardware computer chip 102 with one or more microcontroller, e.g., microcontroller 104 embedded thereon. The computer chip 102 may be considered a single integrated circuit made up of multiple interconnected electronic components. The microcontroller or controller may include one or more processors with one or more memories configured to store one or more executable programs or enabling communication with programmable input/output peripherals and may have firmware programmed into it or otherwise communicatively coupled to software instructions. The microcontroller beneficially includes multiple sensors 108a-n, 110a-n, communicatively coupled and integrated thereto, wherein “n” represents any number greater than one.

Still looking at FIG. 1, the system includes one or more environmental sensors 108a-n that are operably and communicatively coupled with the microcontroller 104 and configured to measure intensity of ambient light, ambient temperature, ambient humidity, atmospheric pressure, and ambient carbon dioxide. Dashed lines depicted in FIG. 1 represent communication lines, whether wired as specified herein or wireless as specified herein. The term “ambient”, unless otherwise described herein, may refer to the environment immediately outside of the sensor and within a range of 36 feet from the sensor and an angular range of approximately 180°. More specifically, ambient detection occurs preferably within 5 m (i.e., approximately 16 ft) and at a degraded ambient presence detection up to 11 m (i.e., approximately 36 ft maximum range). The presence detection describe herein is also operable to detect up to two people.

For example, ambient may be light outside of a housing 112 with the hardware computer chip 102 disposed therein or simply outside of the chip 102. The range may span approximately 20 feet from the light sensor. The sensor technology has a 20-foot range and a 180-degree swath. The housing 112 is preferably formed with a plurality of walls intended to seal the components therein (preferably in a watertight configuration).

In one preferred embodiment, the at least one environmental sensor 108a-n includes a specific hardware a light sensor 108a operably and communicatively coupled with the microcontroller 104 and configured to measure the intensity of the ambient light 108a. Another hardware pressure, temperature, and humidity sensor 108b is utilized, is operably and communicatively coupled with the microcontroller 104, and is configured to measure the ambient temperature, ambient humidity, and atmospheric pressure 108b. These datapoints are utilized by the microcontroller 104 or sensor 108 for presence detection. Another environmental sensor 108 may also be utilized, i.e., a CO₂ sensor 110n that is operably and communicatively coupled with the microcontroller 104 and also configured to measure the ambient carbon dioxide 108n.

Additionally, the system 100 may utilize a separate thermal camera(s) 110a operably and communicatively coupled with the microcontroller 104 that is configured to detect, track, and count a person, animal, or predetermined physical object, The infrared sensor 110a may be incorporated into a thermal camera that is configured to count people, animals, and programmed objects and also configured to obtain the position and traceability and movement of the people, animals, and objects in a room. The thermal camera(s) 110a is also operable to obtain the temperature of each living individual in a room or ambient environment. The thermal camera 110a is also configured to determine temperature of person, animal, object for the purposes of generating a presence detection. Beneficially, each of the environmental sensors 108a-n and the one or more thermal cameras 110a-n are communicatively coupled with the microcontroller 104 with a serial protocol configuration. More specifically, the sensors 108a-n and cameras 110a-n utilize a two-wire serial protocol used to communicate between said sensors and the microcontroller 104 in an embedded system, i.e., two lines serial clock (SCL) and serial data (SDA), wherein SCL is used for clock and SDA is used for data.

The system 100 also beneficially includes one or more radar sensors 110b operably and communicatively coupled with the microcontroller 104 and configured to detect, track, and count a person, animal, or predetermined physical object in an ambient environment with an emitted radio frequency. The radar sensors 110b may operate in a 60-77-GHz range or a millimeter band or range of electromagnetic frequencies between microwaves and infrared. The radar sensor(s) 110b are also beneficially communicatively coupled to the microcontroller 104 using a serial peripheral interface (SPI) configured to send data with separate clock and data lines, along with a select line to choose the device needing to communicate with. In one preferred embodiment, the radar sensor(s) 110b are configured to ascertain the relative speed of the person, animal, or predetermined physical object in the ambient environment with the emitted radio frequency.

The system 100 may also beneficially include at least one passive infrared (PIR) sensor 110c operably and communicatively coupled with the microcontroller 104 and configured to detect changes in ambient infrared radiation. Said another way, the PIR sensor 110c is configured to detect changes in received infrared radiation allowing for detection of the presence of people, animals, and objects in a room. Said differently, the PIR sensor 110c may measure emitted infrared light in its field of view. The PIR sensor 110c is configured to detect infrared radiation that is reflected or released from the target instead of measuring or sensing heat.

Preferably, a second microcontroller 122 is utilized in the system 100 to selectively and wirelessly communicatively couple with an ancillary electronic computing device (e.g., data hubs or nodes, such as home sensors) and provide presence signals thereto, thereby preventing the microcontroller 104 from reducing its processing power when receiving presence detection data from the sensors communicatively coupled to the microcontroller 104. More specifically, the microcontroller 104 may be operable to enable communication protocols used with Wi-Fi IEEE 802.11 b/g/n 2.4 GHz and Bluetooth, wherein the second microcontroller 122 may be dedicated to data transfer through a low power wireless protocol (e.g., offered under the commercial designation of Zigbee®) that is typically utilized in an IoT data network. Said another way, the second microcontroller 122 may also operate under the IEEE 802.15.4 specification. The second microcontroller 122 is communicatively coupled to the microcontroller 104 with a universal asynchronous receiver-transmitter (UART). The second microcontroller 122 may enable selective communication with ancillary devices through, for example, a mobile software application, wherein visualization of data sent by each individual sensor and the corresponding interpretation algorithm result can be seen. To effectuate communication of the microcontroller 104 with other components, the hardware computer chip 102 may include a network interface 106 operably configured to selectively and communicatively couple an ancillary electronic computing device with the microcontroller 104. The second microcontroller 122 is configured to provide data such as sensor state, presence, temperature, lux, humidity, CO₂, and etc.

In preferred embodiments, the system 100 includes a housing body 112 housing the hardware computer chip 102 with the microcontroller 104, the least one environmental sensor 108a-n, the at least one thermal camera 110a, the at least one radar sensor 110b, and the passive infrared sensor 110c, thereby providing one device configured to provide a singular presence detection electronic-based indicator. The housing body 112 may also define an ethernet port 114 with an ethernet connector 116 disposed therein and electrically and communicatively coupled to the hardware computer chip 102 using, preferably, an SPI interface. As such, the ethernet connector 116 allows the microcontroller 104 to connect to a local data network for management and optionally powering the system 100 electrically. The ethernet connector 116 may also be coupled to an ethernet controller. Additionally, or in lieu of the ethernet port 114 and connector 116, the housing 112 may define a USB port 118 with a USB connector 120 disposed therein that is electrically coupled to the hardware computer chip 102 (preferably through a USB-C configuration). The ethernet port 114 and connector 116 may provide connectivity with a local IP address, providing device management options, or through an embedded landing page on the device (running on the microcontroller 104).

In one embodiment, the housing body 112 also defines one or more LED indicator port(s) 126 with one or more LED(s) 128 individually disposed therein that are communicatively coupled to the microcontroller 104, the at least one environmental sensor 108a-n, and the at least one passive infrared sensor 110c. The LEDs 128 may be configured to indicate (i.e., by emitting colored light or pulsed light) to the user of the system's state (e.g., a presence detection electronic-based indicator, presence data from one or more of the sensors, etc.).

In additional embodiments of the present invention, the system 100 beneficially utilizes one or more beacons 124 in the presence detection algorithm. More specifically, the microcontroller 104 is operably configured to receive a universally unique identifier from a portable beacon 124 associated using a short-range wireless low energy protocol, wherein the universally unique identifier includes a physical location of the portable beacon 124. Said another way, the main controller 104 receives and interprets, using a low energy protocol (as described above), signals emitted by one or more beacon(s) achieving a translation of their respective position and movement in real-time. These beacons 124 are hardware transmitters that broadcast their identifier and other bytes of data to nearby electronic devices, e.g., the microcontroller 104 so the beacon 124 can be used to determine the physical location of an object.

Beneficially, the microcontroller 104 is operably configured to independently receive presence signals from each of the one or more environmental sensors 108a-n, the one or more thermal camera 110a, the one or more radar sensors 110b, and the one or more infrared sensors 110c, wherein preferably there are only three environmental sensors 108a-c, one thermal camera 110a, one radar sensor 110b, and one passive infrared sensor 110c. The microcontroller 104 is beneficially configured to execute a programmed presence algorithm utilizing the presence signals from the sensors to generate a presence detection electronic-based indicator, e.g., an electronic notification to an ancillary electronic device of a security professional tasked with monitoring a building space or in a home security system communicatively coupled to an emergency response facility.

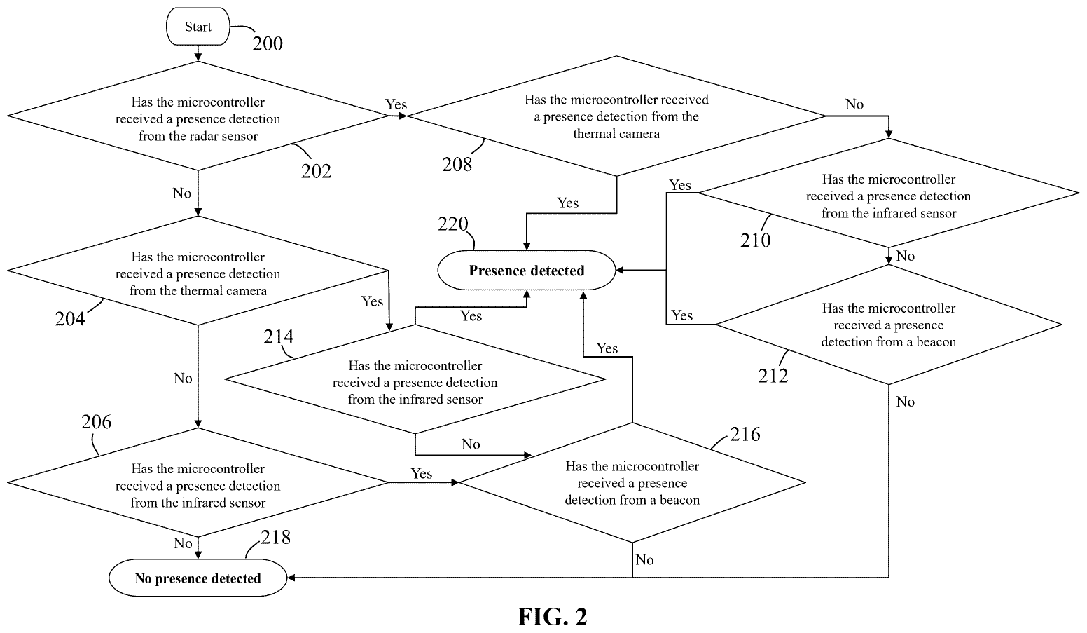

With reference to FIG. 1 in combination with the process flow diagram depicted in FIG. 2, a programmed presence algorithm process or method operation associated with the hardware-based presence sensor system is now described. Specifically, the process may begin at step 200 with receiving power and initializing an executable program on a memory disposed on the chip 102 or microcontroller 104. The beginning step may also include reviewing the configuration status of each sensor the controller 104 manages and, based on the dimensions of a room where the sensors are present, the algorithm calibrates all the sensors the controller 104 manages and then initializes them with the appropriate configuration for the room to be monitored. The method may immediately proceed to step 202 of ascertaining whether the microcontroller 104 has received a presence detection from the radar sensor 110b. If not, the process may proceed to step 204 of ascertaining whether the microcontroller 104 has received a presence detection from the thermal camera 110a. If not, the process may continue to step 206 of ascertaining whether the microcontroller 104 has received a presence detection from the infrared sensor 110c, wherein if the answer to said query is no, the process will not indicate a presence detection electronic-based indicator, i.e., the final step 218 in the process with no presence is detected.

Said differently, steps 202, 204, 206 may include programmed algorithm in the controller 104 making decisions based on a combination of the number of sensors involved, the information they provide (i.e., absence or presence of an object or target), and a score or weight previously associated with each of them. Based on this, the algorithm establishes a detection threshold to define a transition state, which are either (1) absence, (2) alert state, or (3) presence. Continuing further, the direct transition from absence to presence may be dictated when the algorithm performs an analysis and a provided detection threshold is exceeded. If this threshold is reached or exceeded, the state changes from absence to presence. The transition between these states occurs when at least one sensor detects presence, but this situation is not sufficient to exceed the detection threshold. In this case, the algorithm enters an alert state for a specific time (e.g., 30 seconds), waiting for a second trigger from another sensor indicating presence. If the threshold is exceeded during this time, the state changes to presence. If the threshold is not exceeded within the specified time, the state reverts from alert to absence. The transition from presence to alert state occurs when the number of sensors in the presence state and the associated score fall below the established threshold.

Moving back to step 202, if the answer to said query is yes, then the process may continue to step 208 of ascertaining whether the microcontroller 104 has received a presence detection from the thermal camera 110a, wherein if the answer said query is yes, then the process will indicate a presence detection electronic-based indicator, i.e., the final step 220 in the process with a presence of a person, object, or animal being detected. If the answer to query step 208 is no, then the process may continue to step 210 of ascertaining whether the microcontroller 104 has received a presence detection from the infrared sensor 110c, wherein if the answer said query is yes, then the process will indicate a presence detection electronic-based indicator, i.e., the final step 220 in the process with a presence of a person, object, or animal being detected. If the answer to query step 210 is no, then the process may continue to step 212 of ascertaining if the microcontroller 104 has received a presence detection from a beacon 124, wherein if the answer said query is yes, then the process will indicate a presence detection electronic-based indicator, i.e., the final step 220 in the process with a presence of a person, object, or animal being detected. If the answer to query step 212 is no, the process will not indicate a presence detection electronic-based indicator, i.e., the final step 218 in the process with no presence is detected.

Moving back to step 204, if the answer to said query is yes, then the process may continue to step 214 of ascertaining whether the microcontroller 104 has received a presence detection from the infrared sensor 110c, wherein if the answer said query is yes, then the process will indicate a presence detection electronic-based indicator, i.e., the final step 220 in the process with a presence of a person, object, or animal being detected. If the answer to query step 214 is no, then the process may continue to step 216 of ascertaining if the microcontroller 104 has received a presence detection from a beacon 124, wherein if the answer said query is yes, then the process will indicate a presence detection electronic-based indicator, i.e., the final step 220 in the process with a presence of a person, object, or animal being detected. If the answer to query step 216 is no, the process will not indicate a presence detection electronic-based indicator, i.e., the final step 218 in the process with no presence is detected.

In one embodiment, the exemplary programmed presence algorithm illustrated above utilizes a mathematical weight favoring at least one of the presence signals and each of the presence signals is associated with a positive indication of presence of the person, animal, or predetermined physical object. For example, in order to ascertain a positive indication of presence of the person, animal, or predetermined physical object the algorithm may weight the detection from the beacon 124 and the radar sensor 110b (positive or otherwise) twice as reliable as an indication from the thermal camera 110a or infrared sensor 110c, wherein two no presence detections from the from the thermal camera 110a or infrared sensor 110c and two presence detections from the beacon 124 and the radar sensor 110b will generate a positive indication of presence of the person, animal, or predetermined physical object or other target being detected.

As such, a hardware-based presence sensor system has been disclosed that may be used for many uses and applications. For example, for energy conservation, an air conditioner may utilize the system to control the air conditioner based on presence in zones. Water heaters can also be controlled based on presence. For geriatric care, the system can be utilized to monitor user routines such as when a person wakes up, when they go to sleep, when they go to the kitchen or restroom. A routine is created. When something is outside the routine the system can notify a third party. An example would be when a user that usually wakes up and gets out of bed by 10 am, wherein if the system detects no presence or movement at 10:30 am and the user is still in bed, the system may notify a relative or other party (e.g., via a text message) to check in on the user. For security purposes, the system may use thermal imaging, millimeter radar and infrared and can detect intruders with a high level of certainty. Power Over Ethernet allows for easy backup power by installing an Uninterrupted Power Supply (UPS) connected to the networking equipment. For health monitoring, the system may utilize the millimeter radar will detect minute movements such as breathing allowing the diagnostics of sleep apnea. Thermal imaging can measure body temperature detecting fever in persons. C0₂ detection can alert users of excess C0₂. The system can also be used to automate ventilation systems to vent excess C0₂ from environments. The system can also be used for fall detection, store floor management (e.g., counting for capacity limits at stores and monitoring traffic within stores), and for temperature for health purposes (e.g., entering a place of business temperature of customers can be taken that can be used during pandemics or to limit the spread of pathogens). The system can also be used for home automation, using precise presence detection will allow for high fidelity control and automation in the home and fire prevention and detection using the system for thermal imaging detecting hot spots and can monitor appliances notifying users. Users forgetting a stove or cook top on would be notified of the error preventing a fire. Also, excessive heat in walls or appliances could notify users of potential fires. C0₂ Monitoring can detect fires. The system can also be used for segmentation (i.e., occupancy of changing room or hotels rooms) and hospital bed monitoring (i.e., monitor patients non intrusively, e.g., if a patient should not stand or leave their bed the system can notify hospital personnel and the system can also monitor patient activity).

Although a specific order of executing the process steps has been described or shown based on the preferred embodiment, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A hardware-based presence sensor system comprising:
a hardware computer chip with a microcontroller, with at least one environmental sensor operably and communicatively coupled with the microcontroller and configured to measure intensity of ambient light, ambient temperature, ambient humidity, atmospheric pressure, and ambient carbon dioxide, with at least one thermal camera operably and communicatively coupled with the microcontroller and configured to detect, track, and count a person, animal, or predetermined physical object, with at least one radar sensor operably and communicatively coupled with the microcontroller and configured to detect, track, and count a person, animal, or predetermined physical object in an ambient environment with an emitted radio frequency, and with at least one passive infrared sensor operably and communicatively coupled with the microcontroller and configured to detect changes in ambient infrared radiation, the microcontroller operably configured to independently receive presence signals from each of the at least one environmental sensor, the at least one thermal camera, the at least one radar sensor, and the passive infrared sensor and execute a programmed presence algorithm utilizing the presence signals to generate a presence detection electronic-based indicator.

2. The hardware-based presence sensor system according to claim 1, wherein the hardware computer chip further comprises:
a network interface operably configured to selectively and communicatively couple an ancillary electronic computing device to the microcontroller.

3. The hardware-based presence sensor system according to claim 1, further comprising:
a second microcontroller operably configured to selectively and wirelessly communicatively couple with an ancillary electronic computing device and provide presence signals thereto.

4. The hardware-based presence sensor system according to claim 1, wherein the programmed presence algorithm associates a mathematical weight favoring at least one of the presence signals and each of the presence signals is associated with a positive indication of presence of the person, animal, or predetermined physical object.

5. The hardware-based presence sensor system according to claim 1, wherein the at least one radar sensor is configured to ascertain the relative speed of the person, animal, or predetermined physical object in the ambient environment with the emitted radio frequency.

6. The hardware-based presence sensor system according to claim 1, further comprising:
a housing body housing the hardware computer chip, the least one environmental sensor, the at least one thermal camera, the at least one radar sensor, and the passive infrared sensor, the housing body defining an ethernet port with an ethernet connector disposed therein and electrically and communicatively coupled to the hardware computer chip.

7. The hardware-based presence sensor system according to claim 1, further comprising:
a housing body housing the hardware computer chip, the least one environmental sensor, the at least one thermal camera, the at least one radar sensor, and the passive infrared sensor, the housing body defining a USB port with a USB connector disposed therein and electrically coupled to the hardware computer chip.

8. The hardware-based presence sensor system according to claim 1, wherein the at least one environmental sensor and the at least one thermal camera are communicatively coupled with the microcontroller with a serial protocol configuration.

9. The hardware-based presence sensor system according to claim 8, wherein the at least one environmental sensor further comprises:
a light sensor operably and communicatively coupled with the microcontroller and configured to measure the intensity of the ambient light;
a pressure, temperature, and humidity sensor operably and communicatively coupled with the microcontroller and configured to measure the ambient temperature, ambient humidity, and atmospheric pressure; and
a CO₂ sensor operably and communicatively coupled with the microcontroller and configured to measure the ambient carbon dioxide.

10. The hardware-based presence sensor system according to claim 1, wherein the at least one environmental sensor consists essentially of:
a light sensor operably and communicatively coupled with the microcontroller and configured to measure the intensity of the ambient light;
a pressure, temperature, and humidity sensor operably and communicatively coupled with the microcontroller and configured to measure the ambient temperature, ambient humidity, and atmospheric pressure; and
a CO₂ sensor operably and communicatively coupled with the microcontroller and configured to measure the ambient carbon dioxide.

11. The hardware-based presence sensor system according to claim 1, further comprising:
a housing body housing the hardware computer chip, the least one environmental sensor, the at least one thermal camera, the at least one radar sensor, and the passive infrared sensor, the housing body defining an LED indicator port with at least one LED disposed therein communicatively coupled to the microcontroller, the at least one environmental sensor, and the at least one passive infrared sensor.

12. The hardware-based presence sensor system according to claim 1, wherein the microcontroller is operably configured to receive a universally unique identifier from a portable beacon associated using a short-range wireless low energy protocol, the universally unique identifier including a physical location of the portable beacon.

13. A hardware-based presence sensor system comprising:
a hardware computer chip with a microcontroller operably and communicatively coupled with:
at least one environmental sensor configured to measure intensity of ambient light, ambient temperature, ambient humidity, atmospheric pressure, and ambient carbon dioxide;
at least one thermal camera configured to detect, track, and count a person, animal, or predetermined physical object;
at least one radar sensor configured to detect, track, and count a person, animal, or predetermined physical object in an ambient environment with an emitted radio frequency; and
at least one passive infrared sensor configured to detect changes in ambient infrared radiation, wherein the microcontroller is operably configured to independently receive presence signals from each of the least one environmental sensor, the at least one thermal camera, the at least one radar sensor, and the passive infrared sensor and to execute a programmed presence algorithm utilizing the presence signals to generate a presence detection electronic-based indicator.

14. The hardware-based presence sensor system according to claim 13, wherein the programmed presence algorithm associates a mathematical weight favoring at least one of the presence signals and each of the presence signals is associated with a positive indication of presence of the person, animal, or predetermined physical object.

15. The hardware-based presence sensor system according to claim 13, further comprising:
a housing body housing the hardware computer chip, the least one environmental sensor, the at least one thermal camera, the at least one radar sensor, and the passive infrared sensor, the housing body defining an LED indicator port with at least one LED disposed therein communicatively coupled to the microcontroller, the at least one environmental sensor, and the at least one passive infrared sensor.

16. The hardware-based presence sensor system according to claim 13, wherein the at least one environmental sensor and the at least one thermal camera are communicatively coupled with the microcontroller with a serial protocol configuration.
